(19) United States
(12) Patent Application Publication
(10) Pub. No.: US 2018/0095884 A1
(43) Pub. Date: Apr. 5, 2018

(54) MASS STORAGE CACHE IN NON VOLATILE LEVEL OF MULTI-LEVEL SYSTEM MEMORY

(71) Applicant: INTEL CORPORATION, Santa Clara, CA (US)

(72) Inventors: Maciej KAMINSKI, Gdansk (PL); Piotr WYSOCKI, Gdansk (PL); Slawomir PTAK, Gdansk (PL)

(21) Appl. No.: 15/282,478

(22) Filed: Sep. 30, 2016

(51) Int. Cl. G06F 12/0873; G06F 3/06; G06F 12/0804; G06F 12/0868

(52) U.S. Cl. CPC G06F 12/0873; G06F 2212/313; G06F 3/0659; G06F 3/068; G06F 12/0804; G06F 12/0868; G06F 2212/1024; G06F 2212/205; G06F 2212/221; G06F 2212/2228; G06F 2212/224; G06F 2212/271; G06F 2212/284; G06F 2212/3042; G06F 2212/305; G06F 3/0611

(57) ABSTRACT

An apparatus is described. The apparatus includes a memory controller comprising logic circuitry to implement a mass storage cache in a non volatile region of a system memory. The non volatile region of the system memory is to support execution of program code directly out of the non volatile region system memory.

### FIELD OF INVENTION

The field of invention pertains generally to the computing sciences, and, more specifically, to a mass storage cache in a non volatile level of a multi-level system memory.

### BACKGROUND

A pertinent issue in many computer systems is the system memory. Here, as is understood in the art, a computing system operates by executing program code stored in system memory and reading/writing data that the program code operates on from/to system memory. As such, system memory is heavily utilized with many program code and data reads as well as many data writes over the course of the computing system's operation. Finding ways to improve system memory accessing performance is therefore a motivation of computing system engineers.

### FIGURES

A better understanding of the present invention can be obtained from the following detailed description in conjunction with the following drawings, in which:

FIG. 1 (prior art) shows a traditional disk cache and mass storage local cache;

FIG. 2 shows a computing system having a multi-level system memory;

FIG. 3 shows an improved system having a mass storage cache in a non volatile level of a multi-level system memory;

FIG. 4 shows a write call process;

FIG. 5 shows a read call process;

FIG. 6 shows a method for freeing memory space;

FIG. 7 shows a method for allocating memory space;

FIG. 8 shows a method for handling a page fault;

FIG. 9 shows a computing system.

### DETAILED DESCRIPTION

### 1.0 Disk Cache and Local Mass Storage Cache

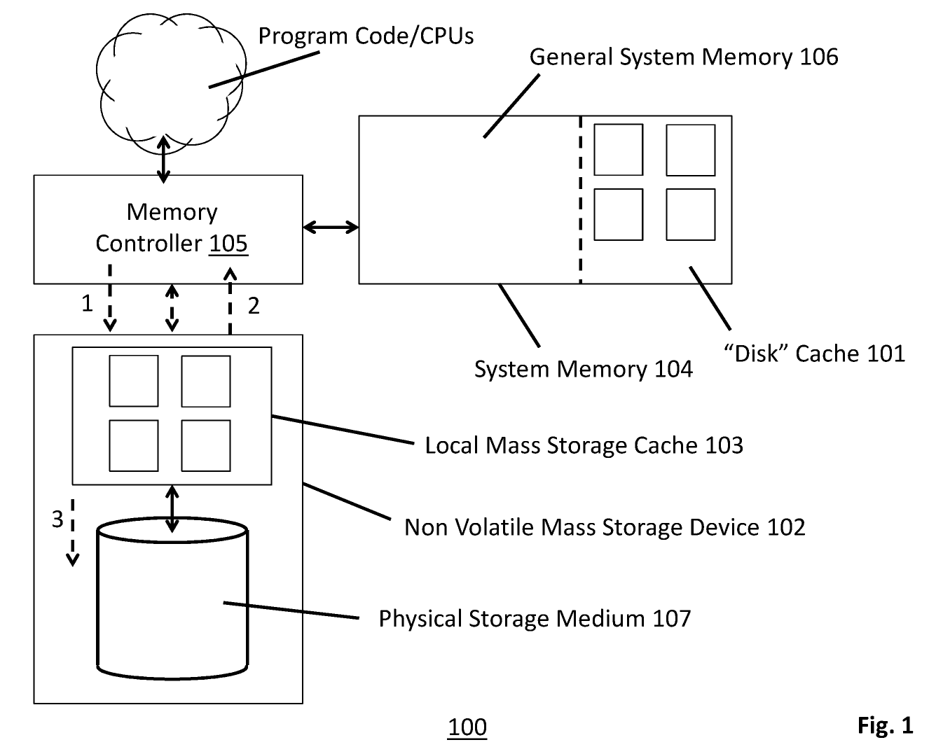

FIG. 1 shows an embodiment of a traditional prior art computing system 100 having a disk cache 101 and a mass storage device 102 having a local cache 103. As is known in the art, CPU processing cores execute program code by reading/writing program code and data from/to system memory 104. In a typical implementation, pages of data and program code are called up from mass non volatile storage 102 and stored in system memory 104.

Program code executing on a CPU core operates out of (reads from and/or writes to) pages that have been allocated in system memory 104 for the program code's execution. Typically, individual system memory loads/stores that are directed to a particular page will read/write a cache line from/to system memory 104.

If a page that is kept in system memory 104 is no longer needed (or is presumed to be no longer be needed) it is removed from system memory 104 and written back to mass storage 102. As such, the units of data transfer between a CPU and a system memory are different than the units of data transfer between a mass storage device and system memory. That is, whereas data transfers between a CPU and system memory 104 are performed at cache line granularity, by contrast, data transfers between a system memory 104 and a mass storage device 102 are performed in much larger data sizes such as one or more pages (hereinafter referred to as a “block” or “buffer”).

Mass storage devices tend to be naturally slower than system memory devices. Additionally, it can take longer to access a mass storage device than a system memory device because of the longer architectural distance mass storage accesses may have to travel. For example, in the case of an access that is originating from a CPU, a system memory access merely travels through a north bridge having a system memory controller 105 whereas a mass storage access travels through both a north bridge and a south bridge having a peripheral control hub (not shown in FIG. 1 for simplicity).

In order to speed-up the perceived slower latency mass storage accesses, some systems include a disk cache 101 in the system memory 104 and a local cache 103 in the mass storage device 102.

As is known in the art, an operating system (or operating system instance or virtual machine monitor) manages allocation of system memory addresses to various applications. During normal operation, pages for the various applications are called into system memory 104 from mass storage 102 when needed and written back from system memory 104 to mass storage 102 when no longer needed. In the case of a disk cache 101, the operating system understands that a region 101 of system memory 104 (e.g., spare memory space) is available to store buffers of data “as if” the region 101 of system memory were a mass storage device. The remaining region 106 of system memory 104 is used for general/nominal system memory functions.

That is, for example, if an application needs to call a new buffer into general system memory 106 but the application's allocated general system memory space is full, the operating system will identify a buffer that is currently in general system memory space 106 and write the buffer into the disk cache 101 rather than into the mass storage device 102.

By so doing, the perceived behavior of the mass storage device 102 is greatly improved because it is operating approximately with the faster speed and latency of the system memory 104 rather than the slower speed and latency that is associated with the mass storage device 102. The same is true in the case where a needed buffer is not in general system memory space 106 and needs to be called up from mass storage 102. In this case, if the buffer is currently being kept in the disk cache 101, the operating system can fetch the buffer from the disk cache region 101 and move it into the application's allocated memory space in the general system memory region 106.

Because the disk cache space 101 is limited, not all buffers that are actually kept in mass storage 102 can be kept in the disk cache 101. Additionally, there is an understanding that once a buffer has been moved from general system memory 106 to mass storage 102 its data content is “safe” from data loss/corruption because mass storage 102 is non volatile. Here, traditional system memory dynamic random access memory (DRAM) is volatile and therefore the contents of the disk cache 101 are periodically backed up by writing buffers back to mass storage 102 as a background process to ensure the buffers' data content is safe.

As such, even with the existence of a disk cache 101, there continues to be movement of buffers between the system memory 104 and the mass storage device 102. The speed of the mass storage device 102 can also be improved however with the existence of a local cache 103 within the mass storage device 102. Here, the local cache 103 may be composed of, e.g., battery backed up DRAM memory. The DRAM memory operates at speeds comparable to system memory 104 and the battery back up power ensures that the DRAM memory devices in the local cache 103 have a non volatile characteristic.

The local cache 103 essentially behaves similar to the disk cache 101. When a write request 1 is received at the mass storage device 102 from the host system (e.g., from a peripheral control hub and/or mass storage controller that is coupled to a main memory controller and/or one or more processing cores), the mass storage device 102 immediately acknowledges 2 the request so that the host can assume that the buffer of information is safely written into the non volatile storage medium 107. However, in actuality, the buffer may be stored in the local cache 103 and is not written back 3 to the non volatile storage medium 107 until sometime later as a background process. In the case of a read request from the host, if the requested buffer is in the local cache 103, the mass storage device 102 can immediately respond by providing the requested buffer from the faster local cache 103 than from the slower non volatile physical storage medium 107.

Although discussions above described a write of a buffer into mass storage 102 as being the consequence of new buffers of information needing to be placed into system memory 104 at the expense of buffers that are already there, in actuality there are software programs or processes, such as database software applications that intentionally “commit” updated information/data to non volatile mass storage 102 in order to secure the state of the information/data at a certain point in time or program execution. Such programs or processes, as part of their normal code flow, include writes of buffers of data to mass storage 102 (referred to as “write call”) in order to ensure that information/data that is presently in the buffer in system memory 104 is not lost because it will be needed or may be needed in the future.

### 2.0 Multi-Level System Memory

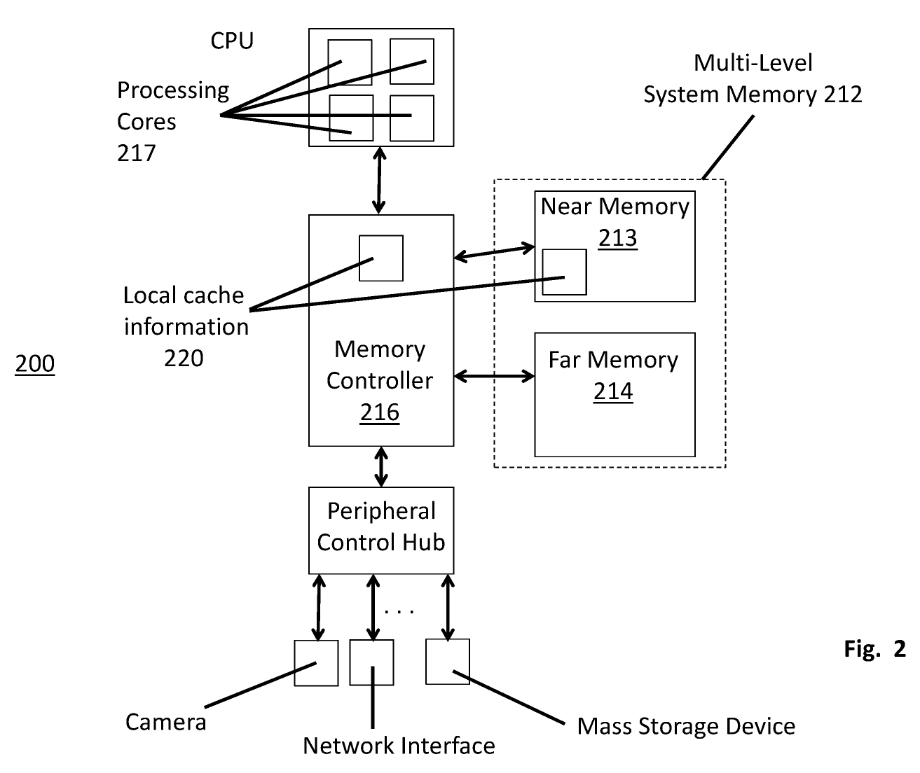

Recall from the Background discussion that system designers seek to improve system memory performance. One of the ways to improve system memory performance is to have a multi-level system memory. FIG. 2 shows an embodiment of a computing system 200 having a multi-tiered or multi-level system memory 212. According to various embodiments, a smaller, faster near memory 213 may be utilized as a cache for a larger far memory 214.

In the case where near memory 213 is used as a cache, near memory 213 is used to store an additional copy of those data items in far memory 214 that are expected to be more frequently used by the computing system. By storing the more frequently used items in near memory 213, the system memory 212 will be observed as faster because the system will often read items that are being stored in faster near memory 213. For an implementation using a write-back technique, the copy of data items in near memory 213 may contain data that has been updated by the CPU, and is thus more up-to-date than the data in far memory 214. The process of writing back ‘dirty’ cache entries to far memory 214 ensures that such changes are preserved in non volatile far memory 214.

According to various embodiments, near memory cache 213 has lower access times than the lower tiered far memory 214 For example, the near memory 213 may exhibit reduced access times by having a faster clock speed than the far memory 214. Here, the near memory 213 may be a faster (e.g., lower access time), volatile system memory technology (e.g., high performance dynamic random access memory (DRAM) and/or SRAM memory cells) co-located with the memory controller 216. By contrast, far memory 214 may be either a volatile memory technology implemented with a slower clock speed (e.g., a DRAM component that receives a slower clock) or, e.g., a non volatile memory technology that is slower (e.g., longer access time) than volatile/DRAM memory or whatever technology is used for near memory.

For example, far memory 214 may be comprised of an emerging non volatile random access memory technology such as, to name a few possibilities, a phase change based memory, a three dimensional crosspoint memory, “write-in-place” non volatile main memory devices, memory devices having storage cells composed of chalcogenide, multiple level flash memory, multi-threshold level flash memory, a ferro-electric based memory (e.g., FRAM), a magnetic based memory (e.g., MRAM), a spin transfer torque based memory (e.g., STT-RAM), a resistor based memory (e.g., ReRAM), a Memristor based memory, universal memory, Ge2Sb2Te5 memory, programmable metallization cell memory, amorphous cell memory, Ovshinsky memory, etc. Any of these technologies may be byte addressable so as to be implemented as a main/system memory in a computing system.

Emerging non volatile random access memory technologies typically have some combination of the following: 1) higher storage densities than DRAM (e.g., by being constructed in three-dimensional (3D) circuit structures (e.g., a crosspoint 3D circuit structure)); 2) lower power consumption densities than DRAM (e.g., because they do not need refreshing); and/or, 3) access latency that is slower than DRAM yet still faster than traditional non-volatile memory technologies such as FLASH. The latter characteristic in particular permits various emerging non volatile memory technologies to be used in a main system memory role rather than a traditional mass storage role (which is the traditional architectural location of non volatile storage).

Regardless of whether far memory 214 is composed of a volatile or non volatile memory technology, in various embodiments far memory 214 acts as a true system memory in that it supports finer grained data accesses (e.g., cache lines) rather than only larger based “block” or “sector” accesses associated with traditional, non volatile mass storage (e.g., solid state drive (SSD), hard disk drive (HDD)), and/or, otherwise acts as an (e.g., byte) addressable memory that the program code being executed by processor(s) of the CPU operate out of.

Because near memory 213 acts as a cache, near memory 213 may not have formal addressing space. Rather, in some cases, far memory 214 defines the individually addressable memory space of the computing system's main memory. In various embodiments near memory 213 acts as a cache for far memory 214 rather than acting a last level CPU cache. Generally, a CPU cache is optimized for servicing CPU transactions, and will add significant penalties (such as cache snoop overhead and cache eviction flows in the case of cache hit) to other system memory users such as Direct Memory Access (DMA)-capable devices in a Peripheral Control Hub. By contrast, a memory side cache is designed to handle, e.g., all accesses directed to system memory, irrespective of whether they arrive from the CPU, from the Peripheral Control Hub, or from some other device such as display controller.

In various embodiments, system memory may be implemented with dual in-line memory module (DIMM) cards where a single DIMM card has both volatile (e.g., DRAM) and (e.g., emerging) non volatile memory semiconductor chips disposed in it. In an embodiment, the DRAM chips effectively act as an on board cache for the non volatile memory chips on the DIMM card. Ideally, the more frequently accessed cache lines of any particular DIMM card will be accessed from that DIMM card's DRAM chips rather than its non volatile memory chips. Given that multiple DIMM cards may be plugged into a working computing system and each DIMM card is only given a section of the system memory addresses made available to the processing cores 217 of the semiconductor chip that the DIMM cards are coupled to, the DRAM chips are acting as a cache for the non volatile memory that they share a DIMM card with rather than as a last level CPU cache.

In other configurations DIMM cards having only DRAM chips may be plugged into a same system memory channel (e.g., a double data rate (DDR) channel) with DIMM cards having only non volatile system memory chips. Ideally, the more frequently used cache lines of the channel are in the DRAM DIMM cards rather than the non volatile memory DIMM cards. Thus, again, because there are typically multiple memory channels coupled to a same semiconductor chip having multiple processing cores, the DRAM chips are acting as a cache for the non volatile memory chips that they share a same channel with rather than as a last level CPU cache.

In yet other possible configurations or implementations, a DRAM device on a DIMM card can act as a memory side cache for a non volatile memory chip that resides on a different DIMM and is plugged into a same or different channel than the DIMM having the DRAM device. Although the DRAM device may potentially service the entire system memory address space, entries into the DRAM device are based in part from reads performed on the non volatile memory devices and not just evictions from the last level CPU cache. As such the DRAM device can still be characterized as a memory side cache.

In another possible configuration, a memory device such as a DRAM device functioning as near memory 213 may be assembled together with the memory controller 216 and processing cores 217 onto a single semiconductor device or within a same semiconductor package. Far memory 214 may be formed by other devices, such as slower DRAM or non-volatile memory and may be attached to, or integrated in that device. Alternatively, far memory may be external to a package that contains the CPU cores and near memory devices. A far memory controller may also exist between the main memory controller and far memory devices. The far memory controller may be integrated within a same semiconductor chip package as CPU cores and a main memory controller, or, may be located outside such a package (e.g., by being integrated on a DIMM card having far memory devices).

In still other embodiments, at least some portion of near memory 213 has its own system address space apart from the system addresses that have been assigned to far memory 214 locations. In this case, the portion of near memory 213 that has been allocated its own system memory address space acts, e.g., as a higher priority level of system memory (because it is faster than far memory) rather than as a memory side cache. In other or combined embodiments, some portion of near memory 213 may also act as a last level CPU cache.

In various embodiments when at least a portion of near memory 213 acts as a memory side cache for far memory 214, the memory controller 216 and/or near memory 213 may include local cache information (hereafter referred to as “Metadata”) 220 so that the memory controller 216 can determine whether a cache hit or cache miss has occurred in near memory 213 for any incoming memory request.

In the case of an incoming write request, if there is a cache hit, the memory controller 216 writes the data (e.g., a 64-byte CPU cache line or portion thereof) associated with the request directly over the cached version in near memory 213. Likewise, in the case of a cache miss, in an embodiment, the memory controller 216 also writes the data associated with the request into near memory 213 which may cause the eviction from near memory 213 of another cache line that was previously occupying the near memory 213 location where the new data is written to. However, if the evicted cache line is “dirty” (which means it contains the most recent or up-to-date data for its corresponding system memory address), the evicted cache line will be written back to far memory 214 to preserve its data content.

In the case of an incoming read request, if there is a cache hit, the memory controller 216 responds to the request by reading the version of the cache line from near memory 213 and providing it to the requestor. By contrast, if there is a cache miss, the memory controller 216 reads the requested cache line from far memory 214 and not only provides the cache line to the requestor (e.g., a CPU) but also writes another copy of the cache line into near memory 213. In various embodiments, the amount of data requested from far memory 214 and the amount of data written to near memory 213 will be larger than that requested by the incoming read request. Using a larger data size from far memory or to near memory increases the probability of a cache hit for a subsequent transaction to a nearby memory location.

In general, cache lines may be written to and/or read from near memory and/or far memory at different levels of granularity (e.g., writes and/or reads only occur at cache line granularity (and, e.g., byte addressability for writes/or reads is handled internally within the memory controller), byte granularity (e.g., true byte addressability in which the memory controller writes and/or reads only an identified one or more bytes within a cache line), or granularities in between.) Additionally, note that the size of the cache line maintained within near memory and/or far memory may be larger than the cache line size maintained by CPU level caches.

Different types of near memory caching implementation possibilities exist. Examples include direct mapped, set associative, fully associative. Depending on implementation, the ratio of near memory cache slots to far memory addresses that map to the near memory cache slots may be configurable or fixed.

### 3.0 Mass Storage Cache Within Non Volatile Region of Multi-Level System Memory

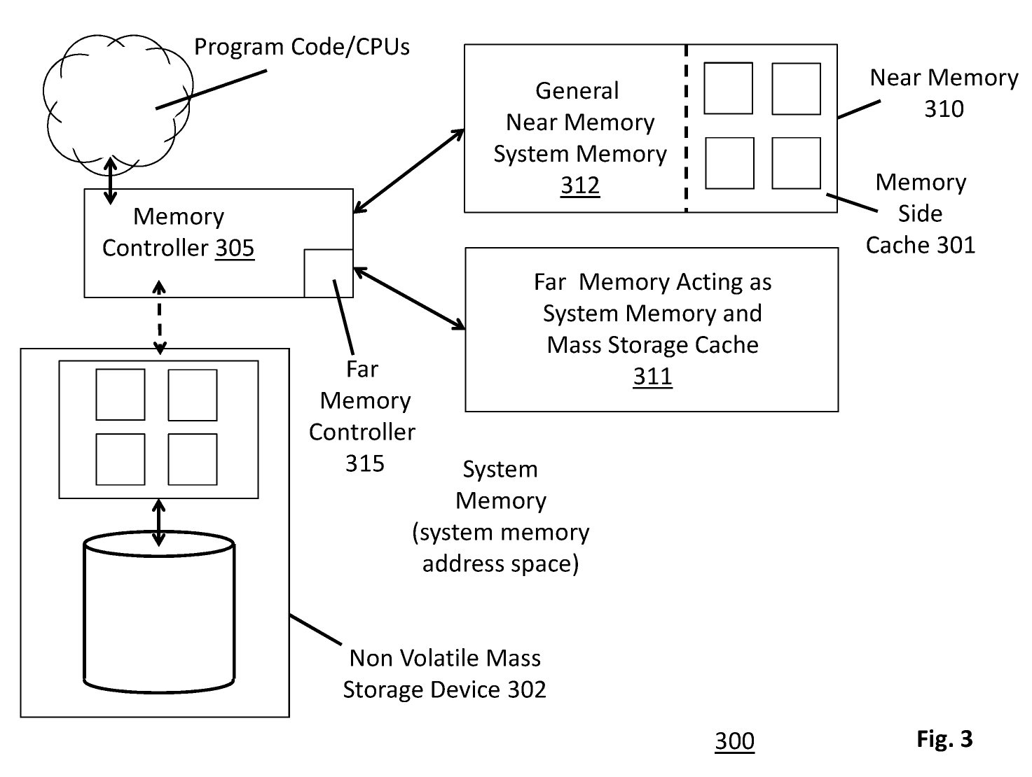

FIG. 3 shows a computing system 300 having a multi-level system memory as described above in the preceding section. The multi-level system memory includes a volatile near memory 310 composed, e.g., of DRAM memory devices, and includes a non volatile far memory 311 composed, e.g., of emerging non volatile memory technology devices (or potentially, battery backed up DRAM). Because the far memory 311 is non volatile, besides it use as a general far memory system memory level as described above in the preceding section, the far memory 311 can also be viewed/used as a mass storage cache.

Here, because far memory 311 is relatively fast and can guarantee non volatility, its use for a mass storage cache as well as system memory can improve system performance as compared to a system having a traditional mass storage local cache 103 because of the far memory based mass storage cache's placement being within system memory 312, 311 Additionally, the existence of a mass storage cache within far memory 311 (instead of local to the remote mass storage device 302) significantly changes traditional operational paradigms/processed as described at length immediately below.

For the sake of example the system 300 of FIG. 3 assumes that mass storage 302 is implemented with a traditional mass storage device such as a hard disk drive or solid state drive. In other embodiments, mass storage may also be provided by emerging non volatile memory devices along with or in lieu of traditional mass storage devices.

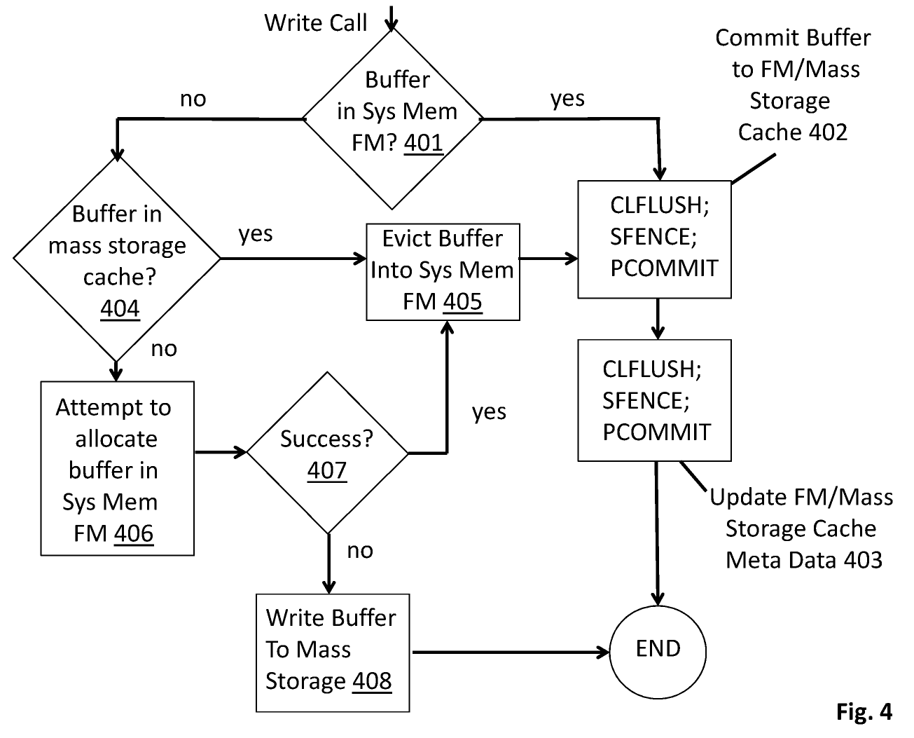

FIG. 4 shows a write call methodology to be executed, e.g., by an operating system or operating system instance, virtual machine, virtual machine monitor, application software program or even hardware with logic circuitry (e.g., in the memory controller 305) or a combination of software and hardware. The method of FIG. 4 is to be compared with a traditional write call described in Section 1.0.

Here, recall from the end of Section 1.0 that some software programs or processes intentionally write data to mass storage (a write call) as part of their normal flow of execution and that execution of a write call physically writes a buffer of information that is a target of the write call from system memory to mass storage. FIG. 4 shows a different way to effectively perform a write call on a system having a non volatile level of system memory 311 that is also viewed/used as mass storage cache.

As observed in FIG. 4, initially, the program code calls out a write call to be executed. Here, in an embodiment, the write call typically specifies a buffer of data, the size of the buffer of data and the file name in mass storage where the buffer is to be stored. According to the methodology of FIG. 4, a determination 401 is made whether the buffer currently resides in the far memory 311 component of system memory. Again, a write call entails the writing of data known to be in system memory into mass storage. Hence, the aforementioned inquiry is directed to system memory component 312 and the storage resources of far memory 311 that are deemed part of system memory and not mass storage cache within far memory 311.

Here, an internal table (e.g., kept by software) resolves the name of the buffer to a base system memory address of the page(s) that the buffer contains. Once the base system memory address for the buffer is known, a determination can be made whether the buffer currently resides in general near memory 312 or far memory 311. Here, e.g., a first range of system memory addresses may be assigned to general near memory 312 and a second range of system memory addresses may be assigned to general far memory 311. Depending on which range the buffer's base address falls within determines the outcome of the inquiry 401.

If the buffer is stored in far memory 311, then a CLFLUSH, SFENCE and PCOMMIT instruction sequence is executed 402 to architecturally “commit” the buffer's contents from the far memory region 311 to the mass storage cache region. That is, even though the buffer remains in place in far memory 311, the CLFLUSH, SFENCE and PCOMMIT instruction sequence is deemed the architectural equivalent as writing the buffer to mass storage, in which case, at least for the buffer that is the subject of the write call, far memory 311 is behaving as a mass storage cache. Note that such movement is dramatically more efficient than the traditional system where, in order to commit a buffer from system memory 102 to the local mass storage cache 103, the buffer had to be physically transported over a much more cumbersome path through the system 100.

As observed in FIG. 4, with the buffer being stored in far memory 311, the CLFLUSH instruction flushes from the processor level caches (caches that reside within a processor or between a processor and system memory) any cache line having the base address of the buffer. The cache line flushing effectively causes a memory store operation to be presented to the system memory controller 305 for each cache line in a processor level cache that is associated with the buffer.

The SFENCE instruction is essentially a message to the system that no further program execution is to occur until all such cache line flushes have been completed and their respective cache lines written to system memory. The PCOMMIT instruction performs the writing of the cache lines into the buffer in far memory 311 to satisfy the SFENCE restriction. After updating the buffer in far memory 311, the buffer is deemed to have been committed into a mass storage cache. At this point, program execution can continue.

The program code may or may not subsequently free the buffer that is stored in far memory 311. That is, according to one possibility, the program code performed the write call to persistently save the current state of the program code but the program code has immediate plans to write to the buffer. In this case, the program code does not free the buffer in system memory after the write call because it still intends to use the buffer in system memory.

By contrast, in another case, the program code may have performed the write call because the program code had no immediate plans to use the buffer but still might need it in the future. Hence the buffer was saved to mass storage for safe keeping, but with no immediate plans to use the buffer. In this case, the system will have to physically move the buffer down to actual mass storage 302 if it intends to use the space being consumed in far memory 311 by the buffer for, e.g., a different page or buffer. The system may do so proactively (e.g., write a copy of the buffer in mass storage 302 before an actual imminent need arises to overwrite it) or only in response to an identified need to use buffer's memory space with other information.

In various embodiments, the memory controller system 305 includes a far memory controller 315 that interfaces to far memory 311 directly. Here, any writing to the buffer in far memory 311 (e.g., to complete the PCOMMIT instruction) is performed by the far memory controller 315. The far memory controller 315, in various embodiments, may be physically integrated with the host main memory controller 305 or be disposed to be external from the host controller 305. For example, the far memory controller 315 may be integrated on a DIMM having far memory devices in which case the far memory controller 315 may be physically implemented in a distributed implementation fashion (e.g., one far memory controller per DIMM with multiple DIMM plugged into the system).

Continuing with a discussion of the methodology of FIG. 4, with the buffer deemed to have been written into a mass storage cache, in an embodiment, the buffer is also marked as read only. Here, the marking of the buffer as read only is architecturally consistent with the buffer being resident in mass storage and not system memory. That is, if the buffer were actually stored in mass storage 302, a system memory controller 305 would not able to directly write to the buffer (the buffer is deemed safely stored in mass storage). As such, in various embodiments, when a buffer in far memory 311 is deemed stored in the mass storage cache, the physical memory space consumed by the buffer is deemed no longer part of system memory. In an embodiment, an address indirection table (AIT) maintained by the far memory controller 315 is used to identify the base address/location in far memory 311 where the committed buffer resides. The contents of the AIT, therefore, essentially store a list of buffers that are deemed to have been stored in the mass storage cache in far memory 311. The AIT may be implemented, for example, with embedded memory circuitry that resides within the far memory controller, and/or the AIT may be maintained in far memory 311.

Thus, in an embodiment, after execution of the PCOMMIT instruction 402, meta data for the mass storage cache (e.g., the aforementioned AIT) is updated 403 to change the AIT table to include the buffer that was just written and to reflect another free location in the mass storage cache for a next buffer to be written to for the next PCOMMIT instruction.

As observed in FIG. 4, the update to the meta data 403 is accomplished with another CLFLUSH, SFENCE and PCOMMIT process. That is, a buffer of data that holds the mass storage cache's meta data (e.g., the AIT information) has its cache lines flushed to the main memory controller 305 (CLFLSUH), program flow understands it is prevented from going forward until all such cache flushes complete in system memory (SFENCE) and a PCOMMIT instruction is executed to complete the flushing of the cache lines into far memory 311 so as to architecturally commit the meta-data to mass storage cache.

Referring back to the initial determination 401 as to whether the buffer that is targeted by the write call is kept in system memory far memory 311 or not, if the buffer is not currently kept in system memory far memory 311, inquiry 404 essentially asks if the buffer that is the target of the write call is resident in mass storage cache in far memory 311. Here, e.g., the address of the buffer (e.g., its logical block address (LBA)) can be checked against the mass storage cache's metadata in the AIT that lists the buffers that are deemed stored in the mass storage cache.

If the buffer is in mass storage cache, it is architecturally evicted 405 from the mass storage cache back into system memory far memory. So doing effectively removes the buffer's read-only status and permits the system to write to the buffer in system memory far memory. After the buffer is written to in system memory far memory, another CLFLUSH, SFENCE and PCOMMIT instruction sequence 402 is performed to recommit the buffer back to the mass storage cache. The meta data for mass storage cache is also updated 403 to reflect the re-entry of the buffer back into mass storage cache.

If the buffer that is targeted by the write call operation is not in system memory far memory 311 nor in mass storage cache but is instead in general near memory 312 (software is operating out of the buffer in system memory address space 312 allocated to near memory 310), then there may not be any allocation for a copy/version of the buffer in system memory far memory 311. As such, an attempt is made 406 to allocate space for the buffer in system memory far memory 311. If the allocation is successful 407 the buffer is first evicted 405 from general near memory 312 to system memory far memory and written to with the content associated with the write call. Then the buffer is deemed present into the mass storage cache after a CLFLUSH, SFENCE, PCOMMIT sequence 402 and the mass storage cache meta data is updated 403. If the allocation 407 is not successful the buffer is handled according to the traditional write call operation and is physically transported to the mass storage device for commitment there 408.

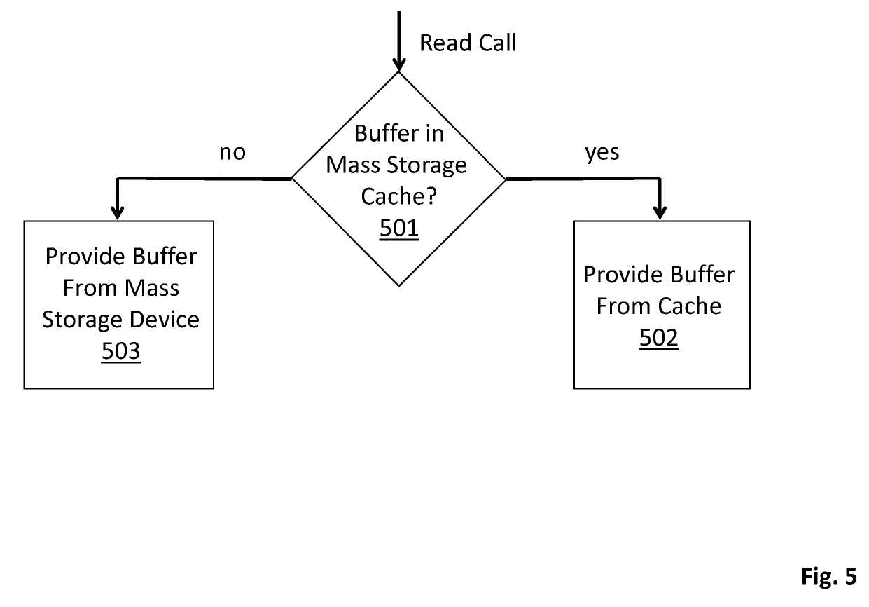

FIG. 5 shows a method for performing a read call. A read call is the opposite of a write call in the sense that the program code desires to read the contents of a buffer that is stored in mass storage rather than writing a buffer to mass storage. Here, referring to FIG. 5, in the case of a read call, the system first looks 501 to the mass storage cache in far memory 311 since the mass storage cache in far memory 311 is effectively a local proxy for actual mass storage. If the buffer is in the mass storage cache (cache hit) the buffer is provided 502 from the mass storage cache (the TLB virtual to physical mapping is changed so the user virtual address points to the buffer in the cache, the read only status is not changed). If the mass storage cache does not have the buffer (cache miss) the buffer is provided 503 from the actual mass storage device 302.

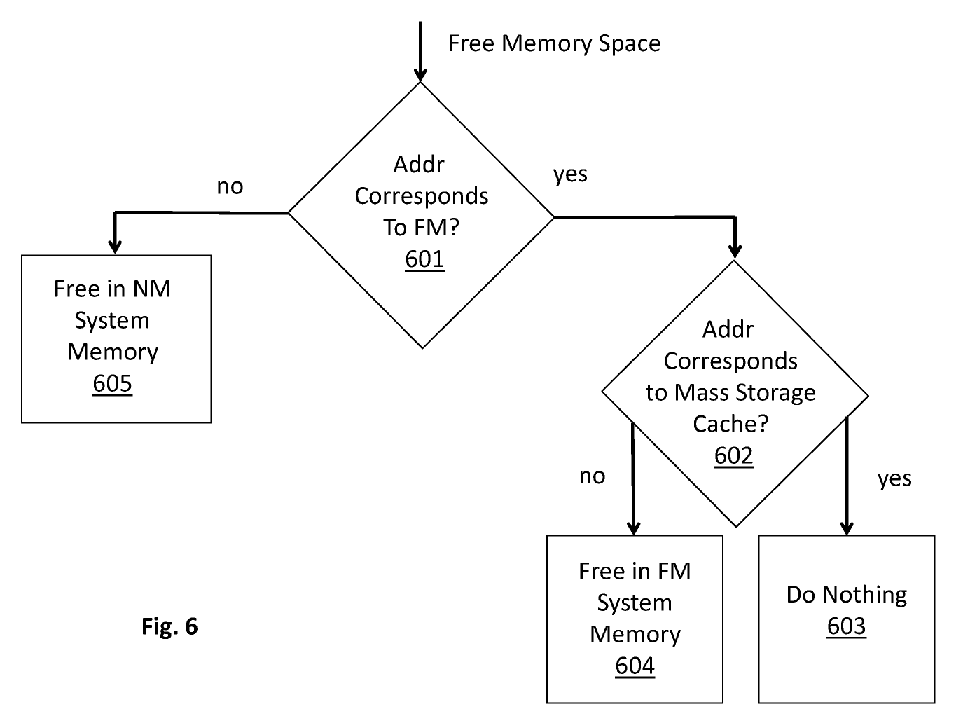

FIG. 6 shows a method for freeing memory space. Here, as is understood in the art, memory space it typically freed in system memory (e.g., for future use) before it can be used. In a situation where a request is made to free 601, 602 memory space that resides in the mass storage cache, no action 603 is taken because the mass storage cache is not deemed to be part of system memory (the address does not correspond to a system memory address). If the region to be freed is not within the mass storage cache but is instead within system memory far memory, the region is freed according to a system memory far memory freeing process 604 or a near memory system memory freeing process 605 (depending on which memory level the requested address resides within).

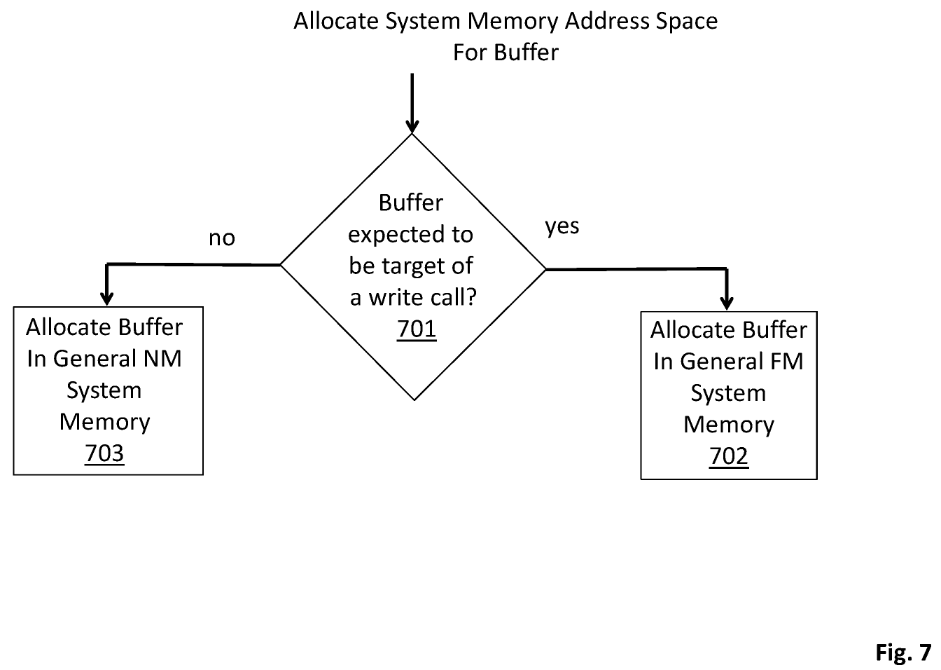

FIG. 7 shows an allocation method that can precede the write call method of FIG. 4. Here, the method of FIG. 7 is designed to select an appropriate system memory level (near memory system memory 312 or far memory system memory 311) for a buffer that is yet to be allocated for in system memory. Here, if the buffer is expected to be the target of a write call or multiple write calls 701, the buffer is assigned to an address in far memory system memory 702. By contrast if the buffer is not expected to be the target of a write call, the buffer is assigned to near memory system memory 703.

The type of application software program that is going to use the buffer can be used to guide the inquiry into whether or not the buffer is expected to be the target of a write call. For example, if the application software program that is going to use the buffer is a database application or an application that executes a two phase commit protocol, the inquiry 701 of FIG. 7 could decide the buffer is a likely candidate to be targeted for a write call. By contrast if the application that the buffer is being allocated for is not known to execute write calls, the inquiry 701 of FIG. 7 could decide the buffer is not a likely candidate to be the target of a write call.

The physical mechanism by which a determination is made that a buffer will be a target of a write call may vary from embodiment. For example, pre-runtime, a compiler may provide hints to the hardware that subsequent program code yet to be executed is prone to writing to the buffer. The hardware acts in accordance with the hint in response. Alternatively, some dynamic (runtime) analysis of the code may be performed by software or hardware. Hardware may also be directly programmed with a static (pre runtime) or dynamic (runtime) indication that a particular software program or region of system memory address space is prone to be a target of a write call.

Recall from the discussion of FIG. 4 above that, in various embodiments, buffers in the mass storage cache are marked as read only. Here, a buffer may correspond to one or more pages. In order to effect read only status, the page(s) that the buffer corresponds to are marked as read only in a translation lookaside buffer (TLB) or other table that translates between two different addresses for a same page (e.g., virtual addresses to physical address). TLB entries typically include meta data for their corresponding pages such as whether a page is read only or not.

It is possible that application or system software that does not fully comprehend the presence or semantics of the mass storage cache may try to write directly to a buffer/page that is currently stored in the mass storage cache. Here, again, in various embodiments mass storage cache is essentially regions of the system hardware's system memory address space that has been configured to behave as a local proxy for mass storage. As such, it is possible that at deeper programming levels, such as BIOS, device driver, operating system, virtual machine monitor, etc., that the mass storage cache appears as an application that runs out of a dedicated portion of system memory.

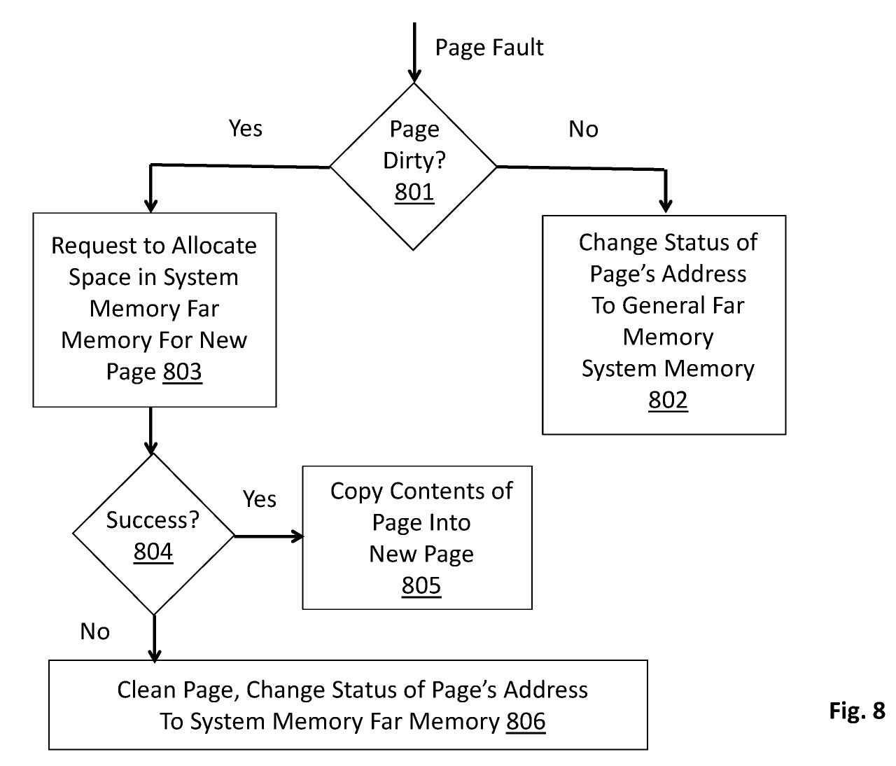

If an attempt is made to write to a page marked as read only, a page fault for the attempted access will be raised. That is, e.g., the access will be denied at the virtual to physical translation because a write was attempted to a page marked as read only. FIG. 8 provides a process for recovering from the page fault. For simplicity the methodology of FIG. 8 assumes the buffer corresponds to only a single page. As observed in FIG. 8, upon the occurrence of the page fault, meta data for the page (which may also be kept in the TLB) is analyzed to see if the page is dirty 801. A dirty page has most recent changes to the page's data that have not been written back to mass the storage device.

If the page is not dirty (i.e. it does not contain any most recent changes to the buffer's data) the page's memory space is affectively given a status change 802 back to system memory far memory 311 and removed from the mass storage cache (i.e., the size of the mass storage cache becomes smaller by one memory page size). The read-only status of the page is therefore removed and the application software is free to write to it. Here, the AIT of the mass storage cache may also need to be updated to reflect that the buffer has been removed from mass storage cache.

If the page is dirty, a request is made 803 to allocate space in system memory far memory. If the request is granted, the contents of the page in the mass storage cache for which the write attempt was made (and a page fault was generated) are copied 805 into the new page that was just created in the system memory far memory and the TLB virtual to physical translation for the buffer is changed to point the buffer's logical address to the physical address of the newly copied page. If the request is not granted the page is “cleaned” 806 (its contents are written back to the actual mass storage device), reallocated to the general far memory system memory region and the page's read only state is removed.

Note that the above described processed may be performed by logic circuitry of the memory controller and/or far memory controller and/or may be performed with program code instructions that causes the memory controller and/or far memory controller to behave in accordance with the above described processes. Both the memory controller and far memory controller may be implemented with logic circuitry disposed on a semiconductor chip (same chip or different chips).

### 4.0 Closing Comments

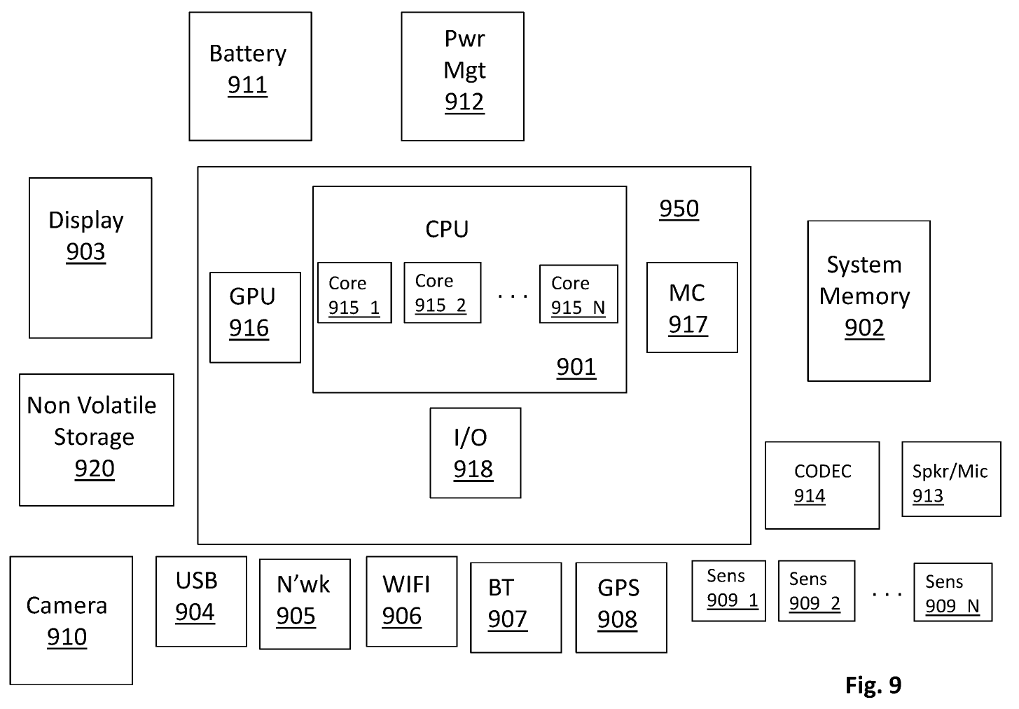

FIG. 9 shows a depiction of an exemplary computing system 900 such as a personal computing system (e.g., desktop or laptop) or a mobile or handheld computing system such as a tablet device or smartphone, or, a larger computing system such as a server computing system. In the case of a large computing system, various one or all of the components observed in FIG. 9 may be replicated multiple times to form the various platforms of the computer which are interconnected by a network of some kind.

As observed in FIG. 9, the basic computing system may include a central processing unit 901 (which may include, e.g., a plurality of general purpose processing cores and a main memory controller disposed on an applications processor or multi-core processor), system memory 902, a display 903 (e.g., touchscreen, flat-panel), a local wired point-to-point link (e.g., USB) interface 904, various network I/O functions 905 (such as an Ethernet interface and/or cellular modem subsystem), a wireless local area network (e.g., WiFi) interface 906, a wireless point-to-point link (e.g., Bluetooth) interface 907 and a Global Positioning System interface 908, various sensors 909_1 through 909_N (e.g., one or more of a gyroscope, an accelerometer, a magnetometer, a temperature sensor, a pressure sensor, a humidity sensor, etc.), a camera 910, a battery 911, a power management control unit 912, a speaker and microphone 913 and an audio coder/decoder 914.

An applications processor or multi-core processor 950 may include one or more general purpose processing cores 915 within its CPU 901, one or more graphical processing units 916, a memory management function 917 (e.g., a memory controller) and an I/O control function 918. The general purpose processing cores 915 typically execute the operating system and application software of the computing system. The graphics processing units 916 typically execute graphics intensive functions to, e.g., generate graphics information that is presented on the display 903. The memory control function 917 interfaces with the system memory 902. The system memory 902 may be a multi-level system memory having a mass storage cache in a non volatile level of the system memory as described above.

Each of the touchscreen display 903, the communication interfaces 904-907, the GPS interface 908, the sensors 909, the camera 910, and the speaker/microphone codec 913, 914 all can be viewed as various forms of I/O (input and/or output) relative to the overall computing system including, where appropriate, an integrated peripheral device as well (e.g., the camera 910). Depending on implementation, various ones of these I/O components may be integrated on the applications processor/multi-core processor 950 or may be located off the die or outside the package of the applications processor/multi-core processor 950.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of software or instruction programmed computer components or custom hardware components, such as application specific integrated circuits (ASIC), programmable logic devices (PLD), digital signal processors (DSP), or field programmable gate array (FPGA).

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a memory controller comprising logic circuitry to implement a mass storage cache in a non volatile region of a system memory, the non volatile region of the system memory to support execution of program code directly out of the non volatile region system memory.

2. The apparatus of claim 1 wherein the logic circuitry comprises address indirection table circuitry comprised of embedded memory circuitry within the memory controller.

3. The apparatus of claim 1 wherein the memory controller is to service a read call to mass storage with a buffer desired by the read call if the buffer is resident in the mass storage cache.

4. The apparatus of claim 1 wherein the logic circuitry is to cause a null response to a request to free system memory space in the mass storage cache.

5. The apparatus of claim 1 wherein the logic circuitry is to allocate a buffer in the non-volatile region of the system memory if the buffer is expected to be a target of a write call.

6. The apparatus of claim 1 wherein the memory controller is to treat a buffer that is resident in the mass storage cache as being within system memory in response to an attempt to write to the buffer's physical address if no previous attempt has been made to write to the buffer's data while the buffer was within the mass storage cache.

7. The apparatus of claim 1 wherein the memory controller is a far memory controller.

8. A machine readable storage medium containing program code that when processed by a computing system causes the system to perform a method, the method comprising:
performing a write call on a buffer within a system memory having a non volatile region and a mass storage cache within the non volatile region, the performing of the write call comprising:
executing a cache line flush instruction to direct any cache lines of the buffer within a processor level cache to a memory controller;
executing a fence instruction to indicate that program execution shall not continue until the cache lines have been written to system memory;
executing a commit instruction to commit the buffer's contents to the mass storage cache.

9. The machine readable storage medium of claim 8 wherein the method further comprises executing respective cache line flush, fence and commit instructions to commit meta data of the mass storage cache to the mass storage cache.

10. The machine readable storage medium of claim 8 wherein the method further comprises marking the buffer as read only as part of its commitment to the mass storage cache.

11. The machine readable storage medium of claim 8 wherein the method further comprises updating meta data of the mass storage cache to reflect the buffer's presence in the mass storage cache.

12. The machine readable storage medium of claim 8 wherein the method further comprises marking the buffer as read only in the mass storage cache and handling a fault in response to an attempt to write to the buffer as follows:
if the buffer's content is not dirty, changing a status of the buffer's content from being in the mass storage cache to being in system memory;
if the buffer's content is dirty, request space in system memory for the buffer's content, if the request is successful copy the buffer's content into the space in system memory, if the request is not successful then cleaning the buffer's content.

13. The machine readable storage medium of claim 8 wherein the method further comprises writing a second buffer in the system memory that is a target of the write call into mass storage because an attempt to allocate space for the buffer in the non volatile region failed.

14. The machine readable storage medium of claim 8 further comprising allocating a buffer that is expected to be a target of a write call into the non volatile region.

15. The machine readable medium of claim 8 further comprising changing a status of a buffer from being read only in the mass storage cache to being writeable in system memory.

16. A computing system, comprising:
one or more processing cores;
a networking interface;
a multi-level system memory;
a memory controller comprising logic circuitry to implement a mass storage cache in a non volatile region of the multi-level system memory, the multi-level system memory to support execution of program code by way of cache line granularity accesses to the multi-level system memory.

17. The computing system of claim 16 wherein the logic circuitry comprises address indirection table circuitry comprised of embedded memory circuitry within the memory controller.

18. The computing system of claim 16 wherein the memory controller is to service a read call to mass storage with a buffer desired by the read call if the buffer is resident in the mass storage cache.

19. The computing system of claim 16 wherein the logic circuitry is to cause a null response to a desire to free memory space in the mass storage cache.

20. The computing system of claim 16 wherein the logic circuitry is to allocate a buffer in the non-volatile region of the multi-level system memory if the buffer is expected to be a target of a write call.

21. The computing system of claim 16 wherein the memory controller is to treat a buffer that is resident in the mass storage cache as being within system memory in response to an attempt to write to the buffer's physical address if no previous attempt has been made to write to the buffer's data while the buffer was within the mass storage cache.

22. The computing system of claim 16 wherein the memory controller is a far memory controller.
